(19) United States
(12) Patent Application Publication
(10) Pub. No.: US 2012/0010069 A1
(43) Pub. Date: Jan. 12, 2012

(54) METHOD OF PRODUCING CORE-SHELL CATALYST PARTICLE AND CORE-SHELL CATALYST PARTICLE PRODUCED BY THIS PRODUCTION METHOD

(75) Inventors: Naoki TAKEHIRO, Suntou-gun (JP); Hiroko KIMURA, Susono-shi (JP); Tatsuya ARAI, Susono-shi (JP); Atsuo IIO, Suntou-gun (JP)

(73) Assignee: TOYOTA JIDOSHA KABUSHIKI KAISHA, Toyota-shi (JP)

(21) Appl. No.: 13/180,081

(22) Filed: Jul. 11, 2011

(30) Foreign Application Priority Data
Jul. 9, 2010 (JP) 2010-156993

(51) Int. Cl. B01J 37/025; B01J 23/44; B01J 23/50; B01J 23/46; B01J 23/75; B01J 23/745; B01J 23/755; B01J 23/42; B01J 23/52; B01J 35/02; B01J 37/34; B01J 23/72; B82Y 40/00

(52) U.S. Cl. 502/5; 502/300; 502/339; 502/347; 502/325; 502/345; 502/338; 502/337; 502/344; 977/890

(57) ABSTRACT

A method of producing a core-shell catalyst particle, the method including: preparing a core particle that contains an alloy including a first core metal having a standard electrode potential of at least 0.6 V and a second core metal having a standard electrode potential lower than that of the first core metal; eluting the second core metal at least at a surface of the core particle, the elution being carried out under conditions at which an equilibrium is maintained for the first core metal between a metal state and a hydroxide and at which an equilibrium is maintained for the second core metal between a metal state and a metal ion; and, with the core particle being designed as a core portion, coating this core portion with a shell portion after the elution of the second core metal.

### INCORPORATION BY REFERENCE

The disclosure of Japanese Patent Application No. 2010-156993 filed on Jul. 9, 2010 including the specification, drawings and abstract is incorporated herein by reference in its entirety.

### BACKGROUND OF THE INVENTION

1. Field of the Invention

The invention relates to a method for producing a core-shell catalyst particle and to a core-shell catalyst particle produced by this production method.

2. Description of Related Art

In a fuel cell, fuel and oxidizing agent are supplied to two electrically connected electrodes and the chemical energy is directly converted to electrical energy by the electrochemical oxidation of the fuel. Unlike fossil fuel power plants, fuel cells are not subject to the constraints of the Carnot cycle and exhibit a high energy conversion efficiency. Fuel cells are generally constructed by stacking a plurality of unit cells; the basic structure of each unit cell is a membrane—electrode assembly in which an electrolyte membrane is sandwiched by a pair of electrodes.

Supported platinum and platinum alloys have been used as anode and cathode electrocatalysts in fuel cells. However, the amount of platinum required in current state-of-the-art electrocatalysts is still too expensive to enable the industrial realization of fuel cell mass production. Research has thus been carried out into combining platinum with less expensive metals in order to lower the amount of platinum in fuel cell cathodes and anodes.

One area of research into combinations of platinum with less expensive metals involves the deposition of a monoatomic layer of platinum on a palladium nanoparticle. As technology that applies this research, Published Japanese Translation of PCT Application No. 2008-525638 (JP-A-2008-525638) discloses a method in which a metal salt or metal salt mixture is brought into contact with hydrogen-absorbed palladium or palladium alloy particles in order to deposit a sub-monoatomic or monoatomic metal coating or a sub-monoatomic or monoatomic metal alloy coating on the surface of the hydrogen-absorbed palladium or palladium alloy particles, thereby producing metal-coated or metal alloy-coated palladium or palladium alloy particles.

The production of a core-shell particle can include the execution of a surface treatment on the core particle prior to the deposition of the shell layer on the core particle. The surface treatment of a palladium-cobalt alloy core particle (in some instances referred to hereafter as a Pd—Co core particle) is described in the following with reference to the drawings. FIG. 1 is a pH-potential diagram (a Pourbaix diagram) for the palladium-water system, while FIG. 2 is a pH-potential diagram for the cobalt-water system. The case will first be examined of placing the Pd—Co core particle under conditions of pH=0 to 2 and the application of a potential of 0 to 1.2 V in order to coat the surface of the Pd—Co core particle with only palladium. The range that satisfies this pH/potential condition is encompassed in FIGS. 1 and 2 by a frame 1 delineated by a dot-and-dash line. According to FIG. 2, cobalt is present as the cobalt ion (Co²⁺) under the conditions in this frame 1. According to FIG. 1, on the other hand, palladium exists in an equilibrium state between the palladium ion (Pd²⁺) and palladium metal under the conditions in frame 1. Based on this, there is a risk that the palladium will end up eluting in addition to cobalt under the conditions of pH=0 to 2 and the application of a potential of 0 to 1.2 V. Due to the difference in surface energies, the eluted palladium ion will selectively deposit as palladium metal on the surface of particles that have a smaller curvature, i.e., particles that have a larger particle diameter. As a consequence, in the equilibrium state, the palladium ion that has eluted from smaller Pd—Co core particles will deposit on the surface of larger Pd—Co core particles. As a result the particle diameter distribution of the Pd—Co core particles will broaden and there is a risk that the durability of the Pd—Co core particles will be diminished. In addition, since palladium is expensive, the eluted palladium ion must be recovered from the solution, incurring the corresponding recovery costs.

### SUMMARY OF THE INVENTION

The invention provides a method of producing a core-shell catalyst particle and provides the core-shell catalyst particle produced by this production method.

An aspect of the invention relates to a method of producing a core-shell catalyst particle that has a core portion and a shell portion that coats this core portion. This production method includes preparing a core particle that contains an alloy including a first core metal having a standard electrode potential of at least 0.6 V and a second core metal having a standard electrode potential lower than that of the first core metal; eluting the second core metal at least at a surface of the core particle, the elution being carried out under conditions at which an equilibrium is maintained for the first core metal between a metal state and a hydroxide and at which an equilibrium is maintained for the second core metal between a metal state and a metal ion; and, with the core particle being designated as a core portion, coating this core portion with a shell portion after the elution of the second core metal.

The second core metal may be eluted by adjusting the pH of the core particle and adjusting the potential applied to the core particle.

This pH may be pH=2 to 4 and the potential may be −0.2 to 1 V.

Taking the aforementioned core particle to be the core portion, the shell portion may be coated on the core portion at least by coating a monoatomic layer on the core portion and replacing the monoatomic layer with the shell portion.

The first core metal may be a metal selected from the group consisting of palladium, silver, rhodium, osmium, and iridium.

The second core metal may be a metal selected from the group consisting of cobalt, copper, iron, and nickel.

The shell portion may contain a metal selected from the group consisting of platinum, iridium, and gold.

The core particle may be supported on a support.

The core-shell catalyst particle of the invention is produced by the production method described hereinabove.

Since in accordance with the invention the elution is brought about of only the second core metal and the elution of the first core metal is not brought about, the particle diameter distribution of the produced core-shell catalyst particles does not undergo broadening and the core-shell catalyst particles are able to maintain their durability. In addition, in accordance with the invention due to the absence of elution of the ion of the first core metal, the recovery of this ion from solution is no longer required and the recovery costs are thus no longer incurred.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a pH-potential diagram for the palladium-water system; and

FIG. 2 is a pH-potential diagram for the cobalt-water system.

### DETAILED DESCRIPTION OF EMBODIMENTS

1. The Method of Producing a Core-Shell Catalyst Article

The method of producing a core-shell catalyst particle that is provided with a core portion and a shell portion covering the core portion, has a step of preparing a core particle that contains an alloy that contains a first core metal having a standard electrode potential of at least 0.6 V and a second core metal having a standard electrode potential lower than that of the first core metal; a step of eluting the second core metal at least at the surface of the core particle, the elution being carried out under conditions at which an equilibrium is maintained for the first core metal between the metal state and the hydroxide and at which an equilibrium is maintained for the second core metal between the metal state and the metal ion; and, with the aforementioned core particle being designated as a core portion, a step of coating this core portion with a shell portion after the elution of the second core metal.

This embodiment has (1) a step of preparing a core particle, (2) a step of preferentially eluting the second core metal in the core particle, and (3) a step of coating the shell portion on the core portion. The invention is not necessarily limited to only these three steps and may, in addition to these three steps, have, for example, a filtration washing step, a drying step, and a pulverization step as described below. These steps (1), (2), and (3) and other steps are described below in sequence.

1-1. The Step of Preparing the Core Particle

In this step, a core particle is prepared that contains an alloy that contains a that core metal having a standard electrode potential of at least 0.6 V and a second core metal having a standard electrode potential lower than that of the first core metal.

The first core metal has a standard electrode potential generally of at least 0.6 V, preferably at least 0.7 V, and particularly preferably at least 0.8 V. The metal exhibiting a high activity for the core-shell catalyst particle that is produced is preferably selected as the first core metal. The first core metal can be exemplified by metals such as palladium, silver, rhodium, osmium, and iridium, whereamong the use of palladium for the first core metal is preferred.

The alloy in the core particle also contains a second core metal that has a standard electrode potential that is lower than that of the first core metal. The second core metal preferably exhibits a high activity of the core-shell catalyst particle that is produced through its presence in the core particle along with the first core metal. The second core metal can be exemplified by a metal selected from the group consisting of cobalt, copper, iron, and nickel, whereamong the use of cobalt or copper for the second core metal is preferred. The alloy in the core particle may be an alloy that contains another metal in addition to the previously described first and second core metals.

Taking the mass of the sum of the first core metal and the second core metal to be 100 mass %, the content of the first core metal in the alloy is preferably 50 to 95 mass %. When the content of the first core metal in the alloy is less than 50 mass %, the lattice constant of this alloy becomes too small and there is a risk that the core particle cannot be uniformly coated by the shell. A content of the first core metal in the alloy of greater than 95 mass % does not lower the amount of use of the first metal.

The average particle diameter of the core particle is to be less than or equal to the average particle diameter of the core-shell metal nanoparticle that has been described above, but is not otherwise particularly limited. Viewed from the perspective of a high ratio for the surface area of the core particle to the cost per core particle, the average particle diameter of the core particle is preferably 4 to 40 nm and particularly preferably is 10 to 20 nm. The average particle diameter of the particles used in the invention can be determined by the usual methods. An example of a method for determining the average particle diameter of the particles is as follows: making the assumption of a spherical shape, the particle diameter is first determined on a specific single particle in the 400,000× to 1,000,000× transmission electron microscope (TEM) image; this determination of the particle diameter by TEM observation is performed on 200 to 300 of the same particles; and the average of these particles is taken to be the average particle diameter.

The core particle may be supported on a support. The support is preferably an electrically conductive material from the standpoint of imparting electrical conductivity to the electrocatalyst layer. Electrically conductive materials that can be used as the support can be specifically exemplified by electroconductive carbon materials such as carbon particles such as Ketjenblack, (trade name, from Ketjen∩Black∩International Co., Ltd.), Vulcan (trade name, from the Cabot Corporation), Norit (trade name, from Norit), Black Pearls (trade name, from the Cabot Corporation), Acetylene Black (trade name, from Chevron), as well as carbon fiber and so forth, and by metals such as metal particles, metal fibers, and so forth.

A core particle may be supported on the support prior to the step of preparing the core particle. Heretofore conventional methods can be used for the method of supporting the core particle on the support. In addition, alloy synthesis and loading of the core particle on the support may be carried out at the same time.

An example is provided in the following of the synthesis of a Pd—Co core particle that uses palladium for the first core metal and cobalt for the second core metal. Palladium nitrate is first immobilized on carbon functioning as a support, and palladium supported on carbon powder is then obtained by a high temperature treatment in an inert atmosphere. Cobalt nitrate is then immobilized on this palladium-bearing carbon powder; a reducing agent such as NaBH₄ is added; and carbon powder supporting a palladium-cobalt alloy is subsequently obtained by a high temperature treatment.

1-2. The Step of Preferentially Eluting the Second Core Metal in the Core Particle

In this step, the second core metal is eluted at least at the surface of the core particle, using conditions at which an equilibrium is maintained for the first core metal between the metal state and the hydroxide and at which an equilibrium is maintained for the second core metal between the metal state and the metal ion.

This step is a step of eluting, at least at the core particle surface, a metal in the alloy other than the first core metal, such as the previously described second core metal. Changing the physical environment and/or the chemical environment in which the core particle resides is a specific example of a method for eluting a metal in the alloy other than the first core metal. More specifically, the core particle is preferably placed under conditions at which, at least at the core particle surface, an equilibrium is maintained for the first core metal between the metal state and the hydroxide and an equilibrium is maintained for the second core metal between the metal state and the metal ion These conditions are conditions in which the second core metal undergoes a suitable repetitive deposition and elution, while the first core metal substantially continues to be present at the core particle surface in a solid slate. Since the first core metal does not undergo elution under these conditions, the particle diameter distribution of the core particle itself does not change. In addition, in those instances in which a noble metal is used as the first core metal, noble metal recovery need not be carried out since the first core metal does not undergo elution under these conditions. Moreover, protrusions and recesses in the core particle surface can be reduced since the first and second core metals present at the core metal surface both move so as to be brought into the most stable state.

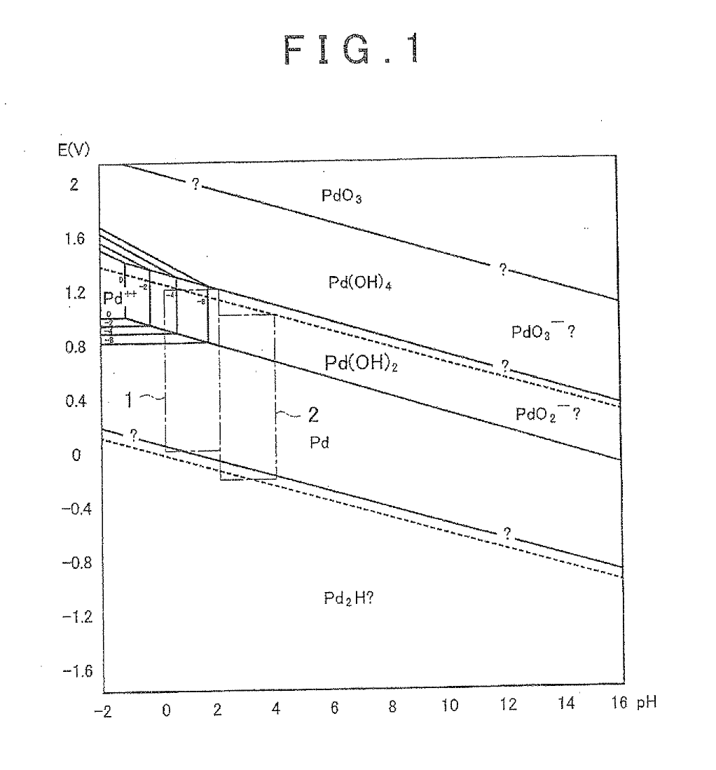

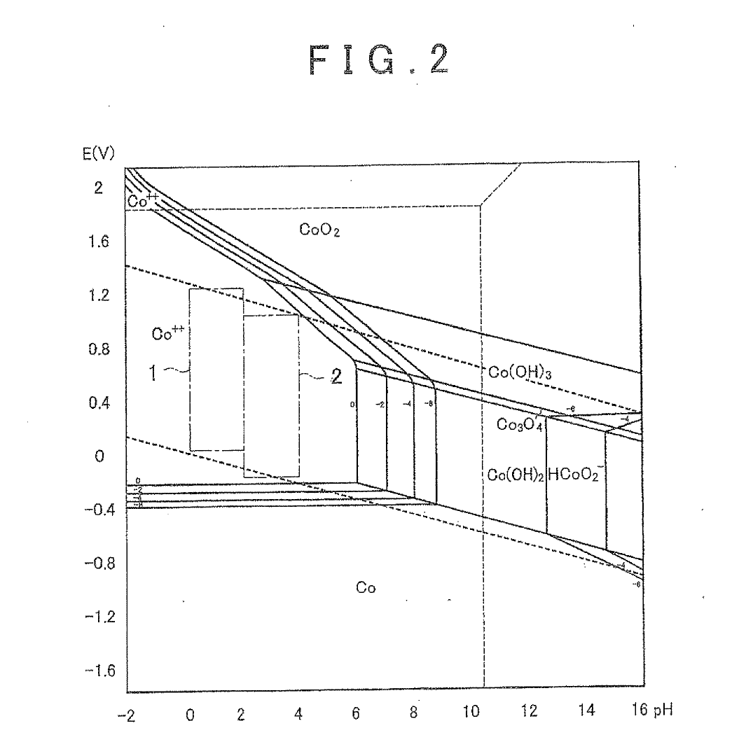

This step is preferably a step in which elution of the second core metal is brought about by adjusting the pH of the core particle and the potential applied to the core particle. As shown in the previously described FIGS. 1 and 2, the conditions for the pH of the core particle and the potential applied to the core particle can be determined with reference, for example, to the pH-potential diagram. Accordingly, the pH and potential conditions can be set as required depending on the combination in the alloy in the core particle. A region wherein the pH interval is about 0 to 3 and the potential interval is about 0.5 to 1.5 V is preferably used for the conditions because this makes setting the conditions convenient.

The case of placing Pd—Co core particles under conditions of pH=2 to 4 and the application of a potential of −0.2 to 1.0 V will now be examined. The regions that satisfy these pH/potential conditions are bounded by the dot-and-dash line delineated frame 2 in FIGS. 1 and 2. According to FIG. 2, cobalt is present in the form of the cobalt ion (Co²⁺) under the conditions within frame 2. On the other hand, according to FIG. 1, palladium resides in an equilibrium state between palladium hydroxide (Pd(OH)₂) and palladium metal under the conditions in frame 2. Based on this, the elution of only cobalt can be brought about, without eluting palladium, under the conditions of pH=2 to 4 and the application of a potential of −0.2 to 1.0 V. Due to this, the particle diameter distribution of the Pd—Co core particles does not undergo broadening and there is no risk of a decline in the durability of the Pd—Co core particles. In addition, since the palladium does not undergo elution, recovery of the palladium ion from the solution is not necessary.

An example of the elution of cobalt from the surface of Pd—Co core particles will be described in the following. The carbon powder bearing Pd—Co core particles is first mixed with a polymer electrolyte, e.g., Nafion (trade name), and this is then coated on a carbon electrode. The surface of the Pd—Co core particles is subsequently brought to 100% palladium by sweeping the potential over the range of potential=−0.2 to 1 V at pH=2 to 4.

1-3. The Step of Coating the Shell Portion on the Core Portion

In this step, with the core particle designated as the core portion, the shell portion is coated on the core portion after elution of the second core metal as described above. The step of coating the shell portion on the core portion may be carried out via a single-step reaction or via a multistep reaction. The description continues below using mainly the example of application of the shell portion via a two-step reaction.

As an example of the coating step implemented via a two-step reaction, at least the following steps are provided: a step of coating a core portion with a monoatomic layer, with the core particle being designated as the core portion; and a step of replacing this monoatomic layer with the shell portion.

This example can be specifically exemplified by a method in which a monoatomic layer is preliminarily formed on the surface of the core portion by an underpotential deposition method followed by replacement of this monoatomic layer with the shell portion. A copper underpotential deposition (Cu-UPD) method is preferably used for the underpotential deposition method. In the particular case in which a palladium alloy particle is used for the core particle and platinum is used for the shell portion, a core-shell metal nanoparticle having a high platinum coverage rate and an excellent durability can be produced by a Cu-UPD method.

A specific example of a Cu-UPD method is described in the following. A powder of palladium alloy supported on an electrically conductive carbon material (designated below as Pd/C) is first dispersed in water and then filtered and the resulting Pd/C paste is coated on the working electrode of an electrochemical cell. The Pd/C paste may be bonded on the working electrode using an electrolyte, e.g., Nation (trade name), as a binder. A platinum mesh or glassy carbon can be used as the working electrode. A copper solution is then added to the electrochemical cell; the aforementioned working electrode and a reference electrode and a counterelectrode are immersed in this copper solution; and a monoatomic layer of the copper is deposited on the palladium alloy particle surface by Cu-UPD. An example of the specific conditions in Cu-UPD is provided below.

copper solution: mixed solution of 0.05 mol/L CuSO₄ and 0.05 mol/L H₂SO₄ (bubbling with nitrogen is carried out)

atmosphere: nitrogen

sweep rate: 0.2 to 0.01 mV/sec

potential: sweep from 0.8 V (vs a reversible hydrogen electrode (RHE)) to 0.4 V (vs RHE) followed by potential clamping at 0.4 V (vs ME)

potential clamping time: 1 to 5 minutes

After the time period in which the potential is fixed is finished, the working electrode is promptly immersed in a platinum solution and displacement plating between the copper and platinum is carried out utilizing the difference in the ionization tendencies. This displacement plating is preferably performed under an inert gas atmosphere, e.g., a nitrogen atmosphere. There are no particular limitations on the platinum solution, and, for example, a platinum solution prepared by dissolving K₂PtCl₄ in 0.1 mol/L HClO₄ can be used. The platinum solution, is thoroughly sired and nitrogen is bubbled into this solution. Displacement plating is preferably maintained for at least 90 minutes. A monoatomic layer of platinum is deposited on the surface of the palladium alloy particle by this displacement plating, thereby yielding the core-shell metal nanoparticle.

The shell portion preferably contains a metal selected from the group consisting of platinum, iridium, and gold, and the shell portion particularly preferably contains platinum.

1-4. Other Steps

Filtration∩washing, drying, and pulverization may be carried out on the core-shell metal nanoparticles after the previously described step of coating the shell portion on the core portion. Filtration∩washing of the core-shell metal nanoparticles is carded out using a method that can remove impurities without damaging the core-shell structure of the produced particles, but is not otherwise particularly limited. This filtration∩washing can be exemplified by a method in which suction filtration is performed using, for example, water, perchloric acid, dilute sulfuric acid, dilute nitric acid, and so forth. The method of drying of the core-shell metal nanoparticles is not particularly limited, as long as the method can remove the solvent and so forth. An example of this drying is a method in which vacuum drying is performed for 0.5 to 2 hours at room temperature followed by drying for 1 to 4 hours at 60° C. to 80° C. in an inert gas atmosphere. The method of pulverization of the core-shell metal nanoparticles is not limited, as long as a solid can be pulverized. This pulverization can be exemplified by pulverization under an inert gas atmosphere or in air using, for example, a mortar, or mechanical milling, for example, a ball mill, turbomill, mechano-fusion, disk mill, and so forth.

2. The Core-Shell Catalyst Particle

The core-shell catalyst particle according to an embodiment of the invention is produced by the production method that has been described in the preceding.

Viewed from the perspective of being able to obtain an additional inhibition of elution of the core portion, the coverage rate by the shell portion of the core portion is preferably 0.8 to 1. When the coverage rate by the shell portion of the core portion is less than 0.8, the risk arises that the core portion will end up eluting in the electrochemical reaction, resulting in a deterioration of the core-shell catalyst particle.

This “coverage rate by the shell portion of the core portion” is the proportion of the surface of the core portion that is covered by the shell portion, taking the total surface of the core portion to be 1. The following is an example of a method for calculating this coverage rate: the surface of the core-shell catalyst particle is observed by TEM at several locations, and the proportion of the area of the core portion, which is determined by the observation to be covered by the shell portion, is calculated with respect to the total area observed.

In a preferred embodiment of the core-shell catalyst particle according to the invention, the core portion is covered by a monoatomic layer shell portion. Such a particle offers the advantages, in comparison to a core-shell catalyst having a shell portion of two or more atomic layers, of a very high catalytic performance for the shell layer and a low material cost due to the small quantity of shell portion application. The average particle diameter of the core-shell metal nanoparticle according to an embodiment of the invention is 4 to 40 nm and preferably 10 to 20 nm. The particle diameter distribution of the core-shell metal nanoparticles is preferably within a range of a value obtained by subtracting 7 nm from the average particle diameter to a value obtained by adding 7 nm to the average particle diameter, more preferably within a range of a value obtained by subtracting 5 nm from the average particle diameter to a value obtained by adding 5 nm to the average particle diameter, and further more preferably within a range of a value obtained by subtracting 3 nm from the average particle diameter to a value obtained by adding 3 nm to the average particle diameter.

What is claimed is:

1. A method of producing a core-shell catalyst particle, comprising:
preparing a core particle that contains an alloy including a first core metal that has a standard electrode potential of at least 0.6 V and a second core metal that has a standard electrode potential lower than that of the first core metal;
eluting the second core metal at least at a surface of the core particle, the elution being carried out under conditions at which an equilibrium is maintained for the first core metal between a metal state and a hydroxide and at which an equilibrium is maintained for the second core metal between a metal state and a metal ion; and
with the core particle being designated as a core portion, coating this core portion with a shell portion after the elution of the second core metal.

2. The production method according to claim 1, wherein the second core metal is eluted by adjusting the pH of the core particle and adjusting a potential applied to the core particle.

3. The production method according to claim 2, wherein the pH is 2 to 4 and the potential is −0.2 to 1 V.

4. The production method according to claim 1, wherein, with the core particle being designated as the core portion, the shell portion is coated on the core portion at least by coating a monoatomic layer on the core portion and replacing the monoatomic layer with the shell portion.

5. The production method according to claim 4, wherein the monoatomic layer is replaced with the shell portion by displacement plating.

6. The production method according to claim 4, wherein the monoatomic layer is coated on the core portion by underpotential deposition.

7. The production method according to claim 6, wherein an atom in the monoatomic layer is copper.

8. The production method according to claim 4, wherein the monoatomic layer is replaced by the shell portion so that a coverage rate of the shell portion to the core portion of 0.8 to 1.

9. The production method according to claim 1, wherein the first core metal is a metal selected from the group consisting of palladium, silver, rhodium, osmium, and iridium.

10. The production method according to claim 9, wherein the first core metal is palladium.

11. The production method according to claim 1, wherein the second core metal is a metal selected froth the group consisting of cobalt, copper, iron, and nickel.

12. The production method according to claim 11, wherein the second core metal is cobalt or copper.

13. The production method according to claim 1, wherein the shell portion includes a metal selected from the group consisting of platinum, iridium, and gold.

14. The production method according to claim 1, wherein the core particle is supported on a support.

15. The production method according to claim 1, wherein the first core metal has a standard electrode potential of at least 0.7 V.

16. The production method according to claim 15, wherein the first core metal has a standard electrode potential of at least 0.8 V.

17. Tice production method according to claim 1, wherein a proportion of the first core metal in the core particle is 50 to 95 mass % when 100 mass % is designated as the mass of a sum of the first core metal and the second core metal.

18. The production method according to claim 1, wherein a core particle average diameter is 4 to 40 nm.

19. The production method according to claim 18, wherein the bore particle average diameter is 10 to 20 nm.

20. A core-shell catalyst particle produced by the production method according to claim 1.
